(19) United States
(12) Patent Application Publication
(10) Pub. No.: US 2015/0025928 A1
(43) Pub. Date: Jan. 22, 2015

(54) METHODS AND SYSTEMS FOR RECOMMENDING EMPLOYEES FOR A TASK

(71) Applicant: XEROX CORPORATION, Norwalk, CT (US)

(72) Inventors: Dhanwant S. Kang, Madison, WI (US); Hua Liu, Bellevue, WA (US); Tong Sun, Penfield, NY (US)

(21) Appl. No.: 13/944,035

(22) Filed: Jul. 17, 2013

(51) Int. Cl. G06Q 10/06

(52) U.S. Cl. CPC G06Q 10/063112
USPC 705/7.14

(57) ABSTRACT

A method, a system, and a computer program product for recommending one or more employees from a group of employees for a task are provided. For an employee in the group of employees a processor is used for determining a degree of separation metric with respect to other employees in the group of employees. Further, for the employee the processor is used for determining a personality metric based at least partially on a measure of past collaboration with other employees in the group of employees. The processor is further used for recommending the one or more employees from the group of employees for the task based on the degree of separation metric and the personality metric.

### TECHNICAL FIELD

The presently disclosed embodiments are directed to determination of relationships among a group of employees. More particularly, the presently disclosed embodiments are related to a technique for recommending employees for a particular task.

### BACKGROUND

Today organizations increasingly look for selecting best teams to take up various tasks in their business processes. Depending on the nature of organizations, such collaborative tasks may range from software product development to various participatory sensing tasks in knowledge creation. The primary factor considered for selecting a team for a particular task is to find the group of employees that can match the requirements of the task. Thus, majority of team formation decisions are usually based on skills, capacity, and schedules of employees. However, many a times it is observed the selected group of employees may not have desired cooperation amongst them, and may not provide the optimal output for the task being performed. Hence, there is a need for a technique that enables the selection of the most suitable team of employees for a given task in the business process of the organization.

Further, it is observed that presently the skills and other attributes of employees are gathered manually (for example, via surveys) by the organization. Such approach is very time-consuming and is not able to capture the change in the preference of employees in real-time. Therefore, there is a need for an efficient technique to collect and collate the information about the skills of the group of employees.

### SUMMARY

According to embodiments illustrated herein, there is provided a computer implementable method for recommending one or more employees from a group of employees for a task. For an employee in the group of employees a processor is used for determining a degree of separation metric with respect to other employees in the group of employees. Further, for the employee the processor is used for determining a personality metric based at least partially on a measure of past collaboration with other employees in the group of employees. The processor is further used for recommending the one or more employees from the group of employees for the task based on the degree of separation metric and the personality metric.

According to embodiments illustrated herein, there is provided a system for recommending one or more employees from a group of employees for a task. The system includes a processor and a memory. The memory includes a closeness determination module configured to determine a degree of separation metric for an employee from the group of employees with respect to other employees in the group of employees. The memory further includes a personality module configured to determine a personality metric of the employee based at least partially on a measure of past collaboration of the employee with the other employees. Additionally the memory includes a recommendation module configured to recommend one or more employees from the group of employees for the task based on at least one the degree of separation metric, or the personality metric. The processor is configured to execute the closeness determination module, the personality module, and the recommendation module.

According to embodiments illustrated herein, there is provided a computer program product for recommending one or more employees from a group of employees for a task. The computer program product includes a computer-usable data carrier storing a computer readable program code for recommending the one or more employees from a group of employees for a task. The computer readable program code includes a program instruction means for identifying one or more skills associated with each employee in the group of employees. The computer readable program code further includes a program instruction means for ranking each employee in the group of employees based at least in part on the one or more skills. Furthermore, the computer readable program code includes a program instruction means for determining a degree of separation metric for an employee from the group of employees with respect to other employees from the group of employees. Additionally, the computer readable program code includes a program instruction means for determining a personality metric of the employee based at least partially on a measure of past collaboration of the employee with the other employees. Finally, the computer readable program code a program instruction means for recommending one or more employees from the group of employees for the task based on at least one the degree of separation metric, or the personality metric.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 illustrates a block diagram illustrating an environment in which various embodiments can be implemented;

FIG. 2 illustrates a block diagram illustrating a system for recommending one or more employees, in accordance with at least one embodiment; and

FIG. 3 illustrates a flowchart illustrating a method for recommending one or more employees, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a computer, a device including a processor/microcontroller and/or any other electronic component, device or system that performs one or more operations according to one or more programming instructions. Examples of the computing device include, but are not limited to, a desktop computer, a laptop, a personal digital assistant (PDA), a Smartphone, or the like. The computing device is capable of accessing (or being accessed over) a network (e.g., using wired or wireless communication capabilities).

A “network” refers to a medium that interconnects a server and various computing devices. Examples of the network include, but are not limited to, LAN, WLAN, MAN, WAN, and the Internet. The communication over the network may be performed in accordance with various communication protocols such as Transmission Control Protocol and Internet Protocol (TCP/IP), User Datagram Protocol (UDP), and IEEE 802.11n communication protocols.

A “task” refers to a piece of work, an activity, an action, a job, an instruction or an assignment to be performed. Tasks may necessitate the involvement of one or more employees. Examples of tasks include, but are not limited to, generating a report, evaluating a document, conducting a survey, writing a code, extraction of data, translating a text, and the like.

An “employee” refers to a worker(s) that may perform one or more tasks, which generate data that contribute to a defined result such as proofreading a part of a digital version of an ancient text or analyzing a quantum of a large volume of data.

A “skill” refers to a learned capacity to carry out various tasks/jobs. In the domain of work, skills can be general (e.g., time management, teamwork, leadership, etc.) or domain specific (e.g., HTML, XML, WSDL, SOAP, JAVA, etc.). While creating an employee profile, the one or more skills can be selected by the employee from a predefined list. The employee may have described his skills in unstructured text as part of the employee profile.

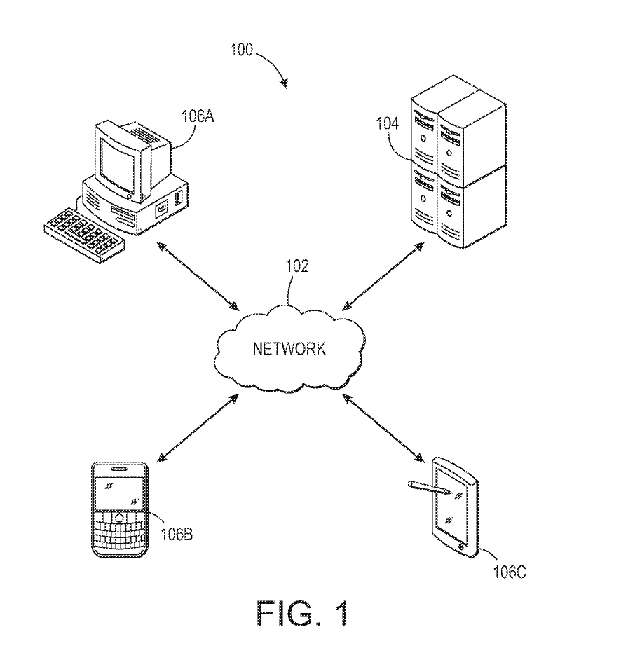

FIG. 1 is a block diagram illustrating an environment 100 in which various embodiments can be implemented. The environment 100 includes a network 102, a server 104, a computing device 106a, a mobile phone 106b, and a personal digital assistant (PDA) 106c. The computing device 106a, the mobile phone 106b, and the personal digital assistant (PDA) 106c are hereinafter referred to as remote devices 106.

In an embodiment, the server 104 manages a group of employees by a registration process of employees in one or more organization. The employees register by providing their employee details to the server 104.

In an embodiment, the server 104 includes a repository of the employee details for the group of employees. In an embodiment, the employee details may include, but are not limited to, employee name, employee ID, web address, email address, or any type of basic information related to the registered the group of employees. In another embodiment, the server 104 may also store performance related details of the group of employees. The performance related details may include, but are not limited to, number of tasks attempted, number of tasks completed correctly, number of tasks completed incorrectly, reputation score, and other such details related to performance of the group of employees.

The remote devices 106 are an interface for the group of employees to receive tasks from the server 104 and for submitting the responses back to the server 104. Examples of the remote devices 106 include, but are not limited to, a computing device, a personal computer (portable or desktop), a laptop, a tablet, a mobile phone, a personal digital assistant (PDA), a Smartphone, pager or any other device, which has capabilities to receive and transmit the information. The remote devices 106 may be operated by an individual or may be programmed to operate automatically (i.e., timed schedule or triggered by an external event).

In an embodiment, the server 104 facilitates recommending of one or more employees from a group of employees for a particular task. The server 104 determines and evaluates various parameters such as skill set, professional closeness, and/or personality of each employee of the group of employees to select the one or more employees. Further, a recommendation model utilized by the server 104 allows the user (project manager) to adjust various parameters according to the task (project) requirements.

In another embodiment, the remote devices 106 are capable of running an application that facilitates recommending of one or more employees from a group of employees for a particular task on a request provided by a user.

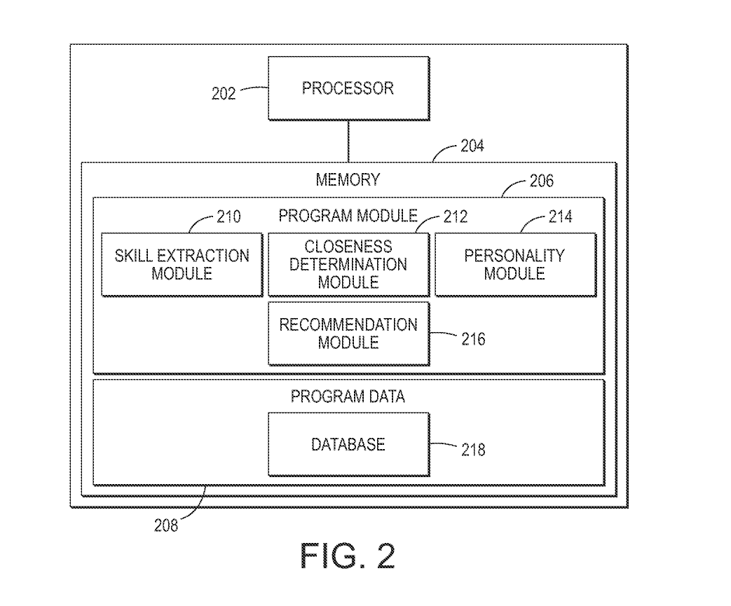

FIG. 2 illustrates a block diagram illustrating a system 200 for recommending the one or more employees from the group of employees for a task, in accordance with at least one embodiment. In an embodiment, the system 200 corresponds to the server 104. In another embodiment, the system 200 corresponds to remote devices 106 such as, a Personal Digital Assistant (PDA), a Smartphone, a tablet PC, a laptop, a personal computer, a mobile phone, a Digital Living Network Alliance (DLNA)-enabled device, or the like.

The system 200 includes a processor 202 and a memory 204. The processor 202 is coupled with the memory 204. The processor 202 is configured to execute a set of instructions stored in the memory 204 to perform one or more operations. The processor 202 fetches the set of instructions from the memory 204 and executes the set of instructions. The processor 202 can be realized through a number of processor technologies known in the art. Examples of the processor include an X86 processor, a RISC processor, or an ASIC processor. In an embodiment, the processor 202 includes a Graphics Processing Unit (GPU) that executes the set of instructions to perform one or more processing operations.

The memory 204 is configured to store the set of instructions or modules. Some of the commonly known memory implementations can be, but are not limited to, a random access memory (RAM), a read-only memory (ROM), a hard disk drive (HDD), and a secure digital (SD) card. The memory 204 includes a program module 206 and a program data 208. The program module 206 includes a set of instructions, divided in various modules, like, a skill extraction module 210, a closeness determination module 212, a personality module 214, and a recommendation module 216. The program module 206 includes. The processor 202 is operable to execute the skill extraction module 210, the closeness determination module 212, the personality module 214, and the recommendation module 216 to perform specific operations on the system 200.

The program data 208 includes a database 218. The database 218 is a storage medium that stores the data submitted from and/or required by the skill extraction module 210, the closeness determination module 212, the personality module 214, and the recommendation module 216. In an embodiment, the database 218 can be implemented using technologies, including, but not limited to Oracle®, IBM DB2®, Microsoft SQL Server®, Microsoft Access®, PostgreSQL®, MySQL®, and SQLite®.

The skill extraction module 210 is configured to determine one or more skills associated with the employees in the group of employees. In an embodiment, the skill extraction module 210 accesses employee profile of each employee in the group of employees from the database 218. In order to extract the skills of the employees, the skill extraction module 210 implements various techniques such as a text processing technique. It will be apparent to a person having ordinary skill in the art that any other suitable technique may be implemented without departing from the scope of disclosed embodiments.

In one embodiment, if the employee profile includes skills present in a predefined list of skills in the database 218, then the skill extraction module 210 identifies the skills, included in the given employee profiles of the group of employees. In another embodiment, if the employee profile includes skills in the unstructured format, the skill extraction module 210 then parses the text in the employee profile. Various less important words (e.g., and, to, for, the, and the like) are eliminated by the skill extraction module 210 from the parsed text. Various skills are then identified by comparing different words (e.g., java, etc.) and short phrases (e.g., web developer, C programmer, etc.) in the parsed text to a set of pre-determined skills.

In yet another embodiment, employees may use different words to describe the same skill set (e.g., HTML, XML, WSDL, and SOAP are all terms that would imply a familiarity with SGML). In order to extract such relations among the skills, the skill extraction module 210 maintains a skill dictionary as a part of the database 218, so that common synonyms can be translated and mapped onto a desired skill hierarchy. In an embodiment, the skill dictionary includes synonym tables to obtain the skill hierarchy. This mapping may then be used later when matching individual's skills (e.g., the first set of skills) against the desired skills (e.g., the second set of skills) for required task accomplishment. The skill extraction module 210 constantly maintains the skill dictionary to add new skills and prune outdated skills.

In another embodiment, the skill extraction module 210 implements an employee skill identification model called probabilistic context aware skill identification model. The probabilistic context aware skill identification model is based on a probabilistic algorithm that may automatically extract employees' skills, interests, and area of concentration from large text corpora. The said model uses a generative probabilistic model that links the employees to observed keywords in documents as well as the source of the documents via latent topics.

Based on any known skill identification model described above without departing from the scope of ongoing description, the skill extraction module 210 will determine employee-skill weights for each year.

In an embodiment, a vector E represents the employees as described below:

Vector E=(e₁, e₂ . . . , eₓ . . . , e_{M})

where

eₓ is the x^{th} employee, and

M is the total number of employees.

In an embodiment, a vector S represents the skills as described below:

Vector S=(s₁, s₂ . . . , sₖ . . . , s_{N})

where,

sₖ is the k^{th} skill type, and

N is the total number of skills.

In an embodiment, the rating of each employee in the group of employees corresponding to all the skills is determined by multiplying E^{T} (i.e., M×1 matrix) and S (i.e., 1×N matrix) resulting in an M x N matrix, where the i^{th} row and j^{th} column represents eᵢ's weight corresponding to skill sⱼ.

In another embodiment, the skill identification model is applied to determine the expertise level of each employee of the group of employees for a skill for the last Y years. Therefore, the skill-weights for all employees for the k^{th} year are represented as θ^{k}=E^{T}×S matrix, where θ_{i,j}^{k} represents an employee eᵢ's weight corresponding to a skill sⱼ for the year k.

Once the employee-skill weight matrix is calculated, a time-factor vector T, which represents the weight corresponding to the employee-skill weight for each year, is defined. In an embodiment, T is initialized in a way such that more weight is given to recent years ratings than previous years.

Thereafter, the skill extraction module 210 is further configured for ranking each employee of the group of employees based on at least the one or more skills. In an embodiment, any suitable ranking algorithm is used to determine the cumulative rank of each employee for each skill represented by a M×N matrix called R, where Rₑₛdenotes the ranking of an employee e for a skill s.

In an embodiment, the sequential procedure of first picking an employee followed by picking a skill, and then generating the cumulative ranking, is shown as below:

$$for all employees e ∈ [ 1 , M ] do$$

$$for all skills s ∈ [ 1 , N ] do$$

$$set {R}_{e , s} := {\sum }_{y = 1}^{Y} \frac{{T}_{y}}{{θ}_{e , s}^{y}}$$

The closeness determination module 212 is configured for determining a degree of separation metric of an employee with respect to other employees in the group of employees. In an embodiment, the degree of separation metric is based a determined amount of professional closeness the employee and the other employees.

In an embodiment, the closeness determination module 212 determines the degree of separation metric in namely three categories. The three categories of degrees of separation metric are defined as degree of separation metric with respect to co-authorship, degree of separation metric with respect to team membership, and degree of separation metric with respect to organizational unit.

In an embodiment, the degree of separation metric with respect to co-authorship is determined by generating a minimum spanning tree (MST) corresponding to the co-authorship network created for all the employees of the group of employees in any given organization. The employees who have co-authored any time in the year yₜ have lesser degree of separation metric as compared to the employees who co-authored in the year yₜ₋₁.

Therefore, in order to measure the degree of separation metric between two given employees, the minimum cost edge between all pairs of employees of the group of employees is calculated. The expression for computing the degree of separation metric with respect to co-authorship is recited below:

$${D}_{i , j}^{c} = \frac{min ( {d}_{i , j} )}{{max}_{u , v ∈ E} ( {d}_{u , v } )}$$

where,

the term min(d_{i,j}) represents the shortest path or the minimum co-authorship distance between two given employees i and j in a co-authorship network, and

the term max_{u,v∈E} (d_{u,v}) represents the maximum co-authorship distance between any two given employees of the group of employees in the organization.

In an embodiment, lesser is the measure value of the degree of separation metric (D_{i,j}^{c}) between the two given employees, the closer is the research interests and skills of the two given employees.

In another embodiment, team structure in an organization is dynamic and the employee is expected to team up with a new set of employees over the period. Thus, the degree of separation metric with respect to team membership is determined relative to the current year. The expression for computing the degree of separation metric with respect to team membership is recited below:

$${D}_{i , j}^{t} = \frac{{y}_{c} - {y}_{t}}{{y}_{c} - {y}_{m i n}}$$

where,

y_{c} represents the current year, yₜ is the latest year when employees i and j were in the same team, and

yₘᵢₙ is the minimum value of the year corresponding to which the organization has team allocation data.

In an embodiment, lesser is the measured value of the degree of separation metric (D_{i,j}^{t}) between two given employees, it is to be noted that more recently they have interacted with each other and better is their social relationship.

In yet another embodiment, the organization structure in the organization is not as dynamic as team structure and generally, an individual is expected to work in the same organization unit for 3-4 years depending on the type of the organization. Thus, the degree of separation metric with respect to organizational unit is determined relative to the current year. The expression for computing the degree of separation metric with respect to organizational unit is recited below:

$${D}_{i , j}^{o} = \frac{{y}_{c} - {y}_{o}}{{y}_{c} - {y}_{m i n}}$$

where,

y_{c} represents the current year, yₒ is the latest year when employees i and j were in the same team, and

yₘᵢₙ is the minimum value of the year corresponding to which the organization has available allocation data.

In an embodiment, the lesser is the measured value of degree of separation metric (D_{i,j}^{o}) between two given employees; the better is social relationship between said two given employees.

In an embodiment, the expression for calculating total degree of separation metric between two employees i and j is recited below:

D_{i,j}=α_{D}D_{i,j}^{c}+β_{D}D_{i,j}^{t}+γ_{D}D_{i,j}^{o}

where,

α_{D}, β_{D}, and γ_{D} are the weights corresponding to different types of degree of separation metric.

The personality module 214 is configured for determining a personality metric of the employee in the group of employees based at least partially on a determined amount of past collaboration of the employee with other employees in the group of employees. The personality of the employees in a team generally affects the team performance. Thus, the personality module 214 is further configured to categorize each employee in the group of employees in at least one of an individual category, a team player category, and an external collaborator category.

In one embodiment, if an employee has higher number of publications as the individual author then said employee would be categorized as the individual player by the personality module 214. The expression for calculating the measure of the individual player personality metric is recited as under:

$${P}_{x}^{i} = \frac{{\sum }_{y = {y}_{m i n}}^{{y}_{c}} {w}_{x}^{i} ( y )}{{\sum }_{y = {y}_{m i n}}^{{y}_{c}} {w}_{x}^{T} ( y )}$$

where,

wₓⁱ(y) is the number of documents that an employee x has authored individually in the y^{th} year, and

wₓ^{T}(y) is the total number of documents authored by the employee x.

In an embodiment, if an employee has higher number of publications with his/her team members then said employee is categorized as a good team player by the personality module 214. The expression for computing the measure of the team player personality metric is recited as under:

$${P}_{x}^{t} = \frac{{\sum }_{y = {y}_{m i n}}^{{y}_{t}} {w}_{x}^{t} ( y )}{{\sum }_{y = {y}_{m i n}}^{{y}_{t}} {w}_{x}^{T} ( y )}$$

where,

wₓ^{t}(y) is the number of documents that an employee x has co-authored with his team and organization unit members in the y^{th} year.

In an embodiment, if an employee has co-authored more publications with employees outside his team, in such scenario said employee is categorized as an external collaborator. The expression for computing the measure of the external collaborator personality metric is recited as under:

$${P}_{x}^{e} = \frac{{\sum }_{y = {y}_{m i n}}^{{y}_{t}} {w}_{x}^{e} ( y )}{{\sum }_{y = {y}_{m i n}}^{{y}_{t}} {w}_{x}^{T} ( y )}$$

where,

wₓ^{e}(y) is the number of documents that an employee x has co-authored outside his team and organizational unit in the y^{th} year.

The recommendation module 216 is configured for recommending one or more employees from the group of employees for the task based on at least one the degree of separation metric, or the personality metric. Thus, according to an embodiment, the recommendation module 216 obtains the cumulative ranking of employees in the group of employees from skill extraction module 210, the measure values of professional closeness of employees with respect to each other from the closeness determination module 212, and the measure of personality from the personality module 214. The recommendation module 216 utilizes the information provided from above-described modules and then creates a recommendation report depending on the task requirement to recommend one or more employees from the group of employees. The one or more recommended employees may be equally good in individual or teamwork.

Thus, it becomes important to determine the distribution of an employee's collaboration style over all three categories discussed above. Following expressions denotes an employee's personality metric based on collaboration

Pₓ=α_{P}Pₓⁱ+β_{P}Pₓ^{t}+γ_{P}Pₓ^{e}

where,

Pₓⁱ is employee x's measure of “individual player” personality (i.e., individual player personality metric),

Pₓ^{t} is employee x's measure of “team player” personality (i.e., team player personality metric),

Pₓ^{e} is employee x's measure of “external collaborator” personality (i.e., external collaborator personality metric),

α_{P} denotes Weight for Pₓⁱ,

β_{P} denotes Weight for Pₓ^{t}, and

γ_{P} denotes Weight for Pₓ^{e}.

In an embodiment, the expression for determining a selection index for two candidate resources i and j corresponding to a skill s for a team is recited below:

$${SI}_{s} ( i , j ) = \frac{{P}_{i} + {P}_{j}}{{D}_{i , j} + {R}_{i , s} + {R}_{j , s}}$$

In an embodiment, the recommendation module 216 recommends the one or more employees from the group of employees with the maximum cumulative selection index value. As per the given requirement for each skill, the recommendation module 216 first determines the feasible one or more employees corresponding to each skill. Later, the recommendation module 216 computes the selection index values for each pair of employees and allocate them in the sub-teams. Thereafter, the recommendation module 216 recommends the sub-team with the maximum selection index.

In an embodiment, the recommendation report is dynamically customizable based on user inputs. The details on the one or more employees listed in the recommendation report are sorted according to the user inputs received when the user is viewing the recommendation report. This can be implemented by storing the recommendation results at the database 218. The recommendation module 216 then filters recommendation results that do not match the user inputs. Thereafter, the recommendation module 216 performs sorting operation to place the remaining recommendation results in the order that the user specifies.

In an embodiment, if the user does not like the recommendation results in the recommendation report, the recommendation module 216 facilitates the user to input feedback on the recommendation report. In an embodiment, the skill extraction module 210 and the recommendation module 216 receives the user feedback.

Thus, the recommendation module 216 facilitates in determination of social connections between the employees and that may result in the increased efficiency of the employees. The efficiency of the employees is directly correlated to the quality of the task responses received from the employees.

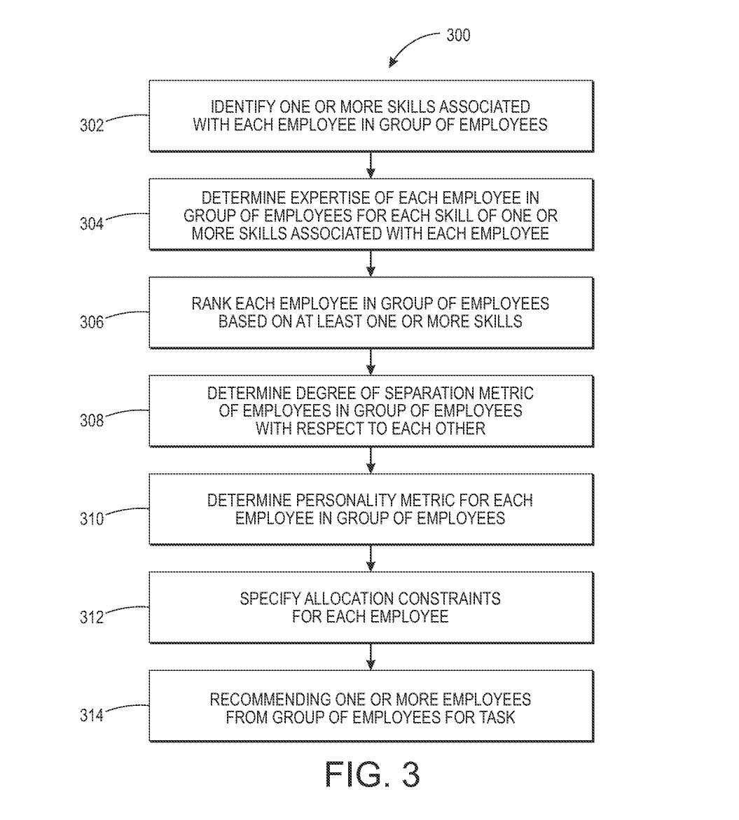

FIG. 3 illustrates a flowchart 300 illustrating a method for recommending one or more employees, in accordance with at least one embodiment.

At step 302, one or more skills associated with each employee in the group of employees are identified. In an embodiment, the skill extraction module 210 determines one or more skills associated with each employee in the group of employees. In an embodiment, the one or more skills include at least one of personal information, educational details, or employment history.

At step 304, expertise of each employee in the group of employees for each skill of the one or more skills associated with the each employee is determined. In an embodiment, the skill extraction module 210 determines the expertise corresponding of each employee in respective skills.

At step 306, each employee in the group of employees is ranked based on at least the one or more skills. In an embodiment, the skill extraction module 210 is configured for ranking each employee in the group of employees based on at least the one or more skills.

At step 308, a degree of separation metric for the employee with respect to other employees in the group of employees is determined. In an embodiment, the closeness determination module 212 is configured for determining the degree of separation metric. The degree of separation metric is based at least partially on a determined amount of professional closeness between two given employees from the group of employees. In an embodiment, the closeness determination module 212 determines the degree of separation metric in namely three categories. The three categories of degrees of separation metric are defined as degree of separation metric with respect to co-authorship, degree of separation metric with respect to team membership, and degree of separation metric with respect to organizational unit.

At step 310, determining a personality metric of each employee in the group of employees based at least partially on a determined amount of past collaboration of employees in the group of employees with respect to each other. In an embodiment, the personality module 214 is configured for determining the personality metric of each employee in the group of employees based on their collaboration with respect to each other. The personality module 214 is further configured to categorize each employee in the group of employees in at least one of an individual category, a team player category, and an external collaborator category.

At step 312, allocation constraints for a given employee from the group of employees are specified at a pre-defined time. In an embodiment, the allocation constraints correspond to maximum number of teams to which the given employee from the group of employees can be allocated.

At step 314, the one or more employees from the group of employees are recommended for the task based on at least the degree of separation metric and the personality metric. In an embodiment, the recommendation module 216 is configured for recommending the one or more employees from the group of employees for the task based on at least one the degree of separation metric, or the personality metric. In another embodiment, the recommendation module 216 is configured for recommending the one or more employees from the group of employees for the task based on the combination of ranking, the degree of separation metric, and the personality metric of each employee of the group of employees.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from an employee through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer readable instructions may include various commands that instruct the processing machine to perform specific tasks such as, steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to employee commands, results of previous processing, or a request made by another processing machine. The disclosure can also be implemented in various operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer program product, as described above, have numerous advantages. Some of these advantages may include, but are not limited to, a fair and robust recommendation technique for the one or more employees for a task. The disclosed recommendation technique constitutes a fair method that takes both the professional closeness and personality type of the employee into consideration. The recommendation methodology facilitates in determination of social connections between the employees and that may result in the increased or optimal efficiency of the employees. The efficiency of the employees is directly correlated to the quality of the task responses received from the employees.

Various embodiments of the disclosure titled “methods and systems for recommending one or more employees for a task” have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method implemented on a computing device for recommending one or more employees from a group of employees for a task, the method comprising:
for an employee in the group of employees: using a processor for
determining a degree of separation metric with respect to other employees in the group of employees; and
determining a personality metric based at least partially on a measure of past collaboration with other employees in the group of employees; and
using the processor for recommending the one or more employees from the group of employees for the task based on the degree of separation metric and the personality metric.

2. The method of claim 1, wherein the processor is further used for identifying one or more skills associated with each employee in the group of employees.

3. The method of claim 2, wherein the processor is further used for ranking each employee in the group of employees based at least in part on the one or more skills.

4. The method of claim 2, wherein the one or more skills comprises at least one of personal information, educational details, or employment history.

5. The method of claim 2, wherein the processor is further used for determining expertise of each employee in the group of employees for each skill of the one or more skills associated with the each employee.

6. The method of claim 1, wherein the degree of separation metric is based at least partially on a determined amount of professional closeness between the employee and other employees in the group of employees.

7. The method of claim 1, wherein the degree of separation is determined based on at least one of co-authorship, team membership, and organizational unit.

8. The method of claim 1, wherein the processor is further used for categorizing each employee in the group of employees in at least one of an individual category, an team player category, and an external collaborator category.

9. The method of claim 8, wherein the categorization of the employee in the individual category is based on a number of publications of the employee as an individual.

10. The method of claim 8, wherein the categorization of the employee in the team player category is based on a number of publications of the employee with other employees in the group of employees.

11. The method of claim 8, wherein the categorization of the employee in the external collaborator category is based on a number of publications of the employee with employees outside the group of employees.

12. The method of claim 1, wherein the processor is further used for specifying allocation constraints for the employee from the group of employees at a time, wherein the allocation constraints corresponds to a maximum number of teams to which the employee can be allocated.

13. A system for recommending one or more employees from a group of employees for a task, the system comprising:
a processor; and
a memory comprising:
a closeness determination module configured to determine a degree of separation metric for an employee from the group of employees with respect to other employees in the group of employees;
a personality module configured to determine a personality metric of the employee based at least partially on a measure of past collaboration of the employee with the other employees; and
a recommendation module configured to recommend one or more employees from the group of employees for the task based on at least one the degree of separation metric, or the personality metric, and
wherein the processor is operable to execute the closeness determination module, the personality module, and the recommendation module.

14. The system of claim 13 further comprising a skill extraction module configured to identify one or more skills associated with each employee the group of employees, wherein the processor executes the skill extraction module.

15. The system of claim 14, wherein the skill extraction module is further configured to ranking each employee in the group of employees based at least in part on the one or more skills.

16. The system of claim 13 further comprising a database for storing one or more skills associated with each employee in the group of employees.

17. The system of claim 13 further comprising a comparison module configured to determine a gap between the one or more skills of the employee with the one or more skills of other employees in the group of employees.

18. The system of claim 13, wherein the degree of separation metric is based at least partially on a determined amount of professional closeness between the employee and other employees in the group of employees.

19. The system of claim 13, wherein the personality module is further configured to categorize each employee in the group of employees in at least one of an individual category, a team player category, and an external collaborator category.

20. A computer program product for use with a computer, the computer program product comprising a computer-usable data carrier storing a computer readable program code embodied therein for recommending one or more employees from a group of employees for a task, the computer readable program code comprising:
program instruction means for identifying one or more skills associated with each employee in the group of employees;
program instruction means for ranking each employee in the group of employees based at least in part on the one or more skills;
program instruction means for determining a degree of separation metric for an employee from the group of employees with respect to other employees from the group of employees;
program instruction means for determining a personality metric of the employee based at least partially on a measure of past collaboration of the employee with the other employees; and
program instruction means for recommending one or more employees from the group of employees for the task based on at least one the degree of separation metric, or the personality metric.
